(19) United States
(12) Patent Application Publication
(10) Pub. No.: US 2009/0095170 A1
(43) Pub. Date: Apr. 16, 2009

(54) MARINADE CONTAINER

(76) Inventors: Lawrence R. Hutzler, Lakeville, CT (US); William Kolano, Pittsburg, PA (US)

Correspondence Address: STRIKER , STRIKER & STENBY, 103 EAST NECK ROAD, HUNTINGTON, NY, 11743, US

(21) Appl. No.: 11/872,147

(22) Filed: Oct. 15, 2007

(51) Int. Cl. A23L 1/01; A22C 9/00; B65D 8/04

(52) U.S. Cl. 99/516; 220/600; 452/141

(57) ABSTRACT

A marinade container has a base element having an inner surface provided with a plurality of tines which are configured for puncturing holes in a surface of a piece of food product, the base element also having an outer surface, and a lid element having an inner surface provided with a plurality of tines which are configured for puncturing holes in a piece of food product, the lid element and the base element being connectable with one another so as to define an inner space in which a piece of food product can be accommodated and the tines on the inner surface of the base element and on the inner surface of the lid element being configured so that when the piece of food product is accommodated in the inner space the tines of the base element puncture holes in one surface of the piece of food product and the tines of the inner surface of the lid element simultaneously puncture holes in an opposite surface of the piece of food product for increasing a diffusion of marinade into the food product and for thereby increasing an effectiveness with which the piece of food product is marinated and made tender.

### BACKGROUND OF THE INVENTION

The present invention relates generally to marinade containers and meat tenderizers.

More particularly, the present invention relates to a sealable marinade container, comprising a base and a lid, which marinades and tenderizes meat and other products.

Sealable containers for marinating meats and other foods are known in the art. They include a marinade container comprising a marinade tray having projecting tines for tenderizing meats.

U.S. Pat. No. 6,869,351 to Kell discloses a marinade tray having a base and lid that seal to form a marinade container. The base of the marinade container is flat and its exterior surface can be used as a cutting board. The interior surface of the base comprises a plurality of tines that puncture the meat in the base to facilitate the diffusion of marinade into the meat. The base can also be used for cooking the meat and the tines transmit heat into the meat to facilitate cooking.

It is believed that the existing marinade containers can be further improved.

### SUMMARY OF THE INVENTION

Accordingly, it is an object of the present invention to provide a marinade container, which is a further improvement of the existing marinade containers.

In keeping with these objects and with others which will become apparent hereinafter, one feature of the present invention resides, briefly stated, in a marinade container, comprising a base element having an inner surface provided with a plurality of tines which are configured for puncturing holes in a surface of a piece of food product, said base element also having an outer surface; and a lid element having an inner surface provided with a plurality of tines which are configured for puncturing holes in a piece of food product, said lid element and said base element being connectable with one another so as to define an inner space in which a piece of food product can be accommodated and said tines on said inner surface of said base element and on said inner surface of said lid element being configured so that when the piece of food product is accommodated in said inner space said tines of said base element puncture holes in one surface of the piece of food product and said tines of said inner surface of said lid element simultaneously puncture holes in an opposite surface of the piece of food product for increasing a diffusion of marinade into the food product and for thereby increasing the effectiveness with which the piece of food product is marinated and made tender.

When the marinade container is designed in accordance with the present invention, not only a piece of food product is punctured from below through its lower surface, but it is also punctured from above through its upper surface, and therefore a diffusion of marinade into a food product is increased, which significantly increases the effectiveness with which the piece of food product is marinated and made tender.

In accordance with another important feature of the present invention, the inner space between the base element and the lid element can be adjusted so as to accommodate pieces of food product of different thicknesses and at the same time to guarantee that both the tines of the inner surface of the base element and the tines of the inner surface of the lid element puncture holes in the lower surface and in the upper surface of the piece of food product.

The adjustment can be performed by deflection of one of the elements, and preferably by the deflection of the lid element relative to the base element. For this purpose the peripheral region of the lid element can be provided with folds or corrugations.

In accordance with still a further feature of the present invention, both the lid element and the base element are provided on the outer surfaces with projections Which can be supported on a supporting surface, so that the marinade container can be arranged in one position in which the base element is located below the bottom and the lid element is located above, and another position in which the lid element is located below the bottom and the base element is located above.

For stacking purposes the outer surfaces of the base element and the lid element can be provided also with depressions in which the above mentioned projections are engageable when several marinade containers are located over one another.

To facilitate the engagement of the projections into the depressions, orienting means are provided for example on an outer surface of the lid element and formed as a periphery closed projection.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a marinade container in accordance with the present invention;

FIG. 2 is a side view of the marinade container in accordance with the present invention;

FIG. 3 is a top view of the marinade container in accordance with the present invention;

FIG. 4 is a bottom view of the marinade container in accordance with the present invention;

FIG. 5 is a perspective view of a base element of the marinade container in accordance With the present invention;

FIG. 6 is a side view of the base element of the marinade container in accordance with the present invention;

FIG. 7 is a top view of the base element of the marinade container in accordance with the present invention;

FIG. 8 is a bottom view of the base element of the marinade container in accordance with the present invention;

FIG. 9 is a perspective view of a lid element of the marinade container in accordance with the present invention;

FIG. 10 is a side view of the lid element of the marinade container in accordance with the present invention;

FIG. 11 is a top view of the lid element of the marinade container in accordance with the present invention;

FIG. 12 is a bottom view of the lid element of the marinade container in accordance with the present invention;

FIG. 13 is a cross-sectional view of the lid element of the marinade container in accordance with the present invention;

FIGS. 14a and 14b are side views of the lid element of the marinade container in accordance with the present invention showing different positions of the lid for conforming to different thickness of a piece of food product;

FIG. 15 is a short side elevation view of a marinade container in accordance with the present invention;

FIG. 16 is a long side elevation view of the marinade container in accordance with the present invention;

FIG. 17 is a perspective view of two containers in accordance with the present invention, that are stacked on top of each other; and

FIG. 18 is a side view of the two containers in accordance with the present invention which are stacked on top of each other.

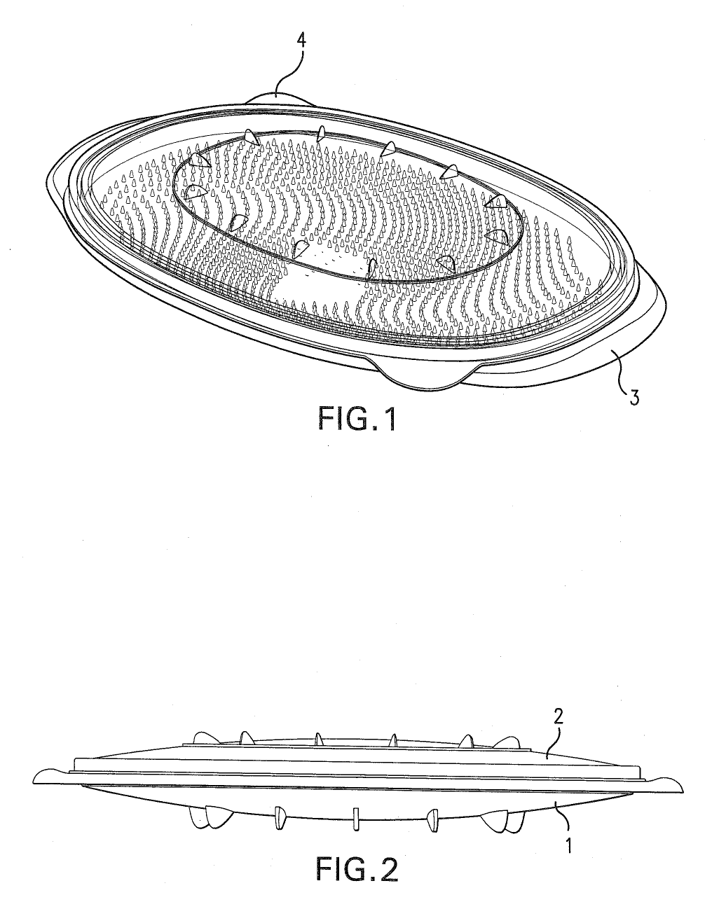

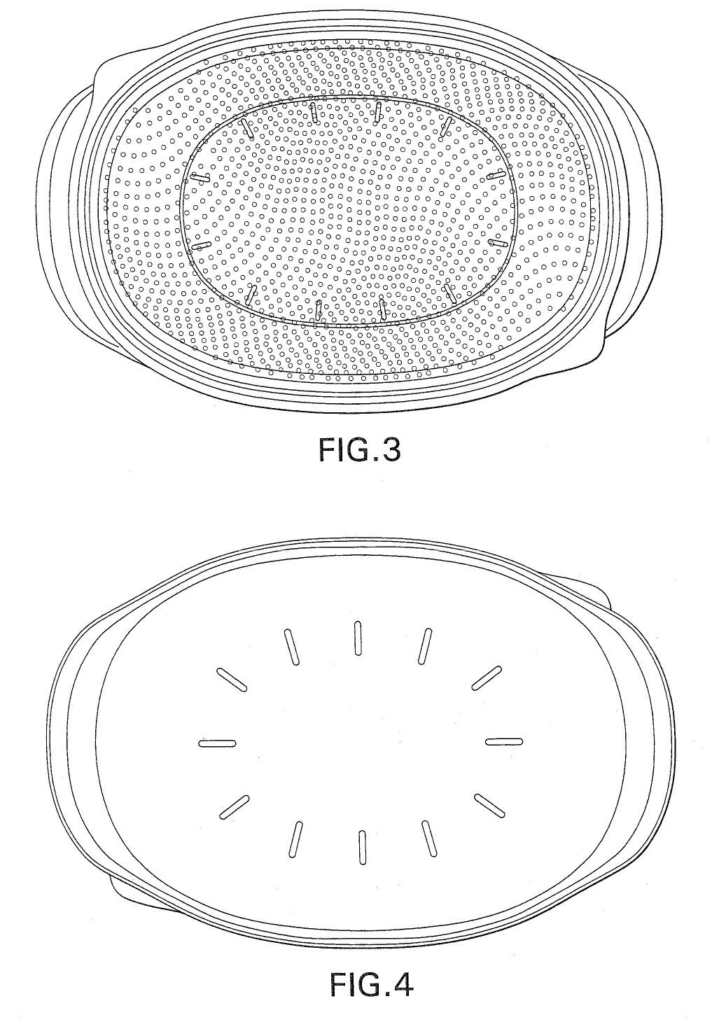

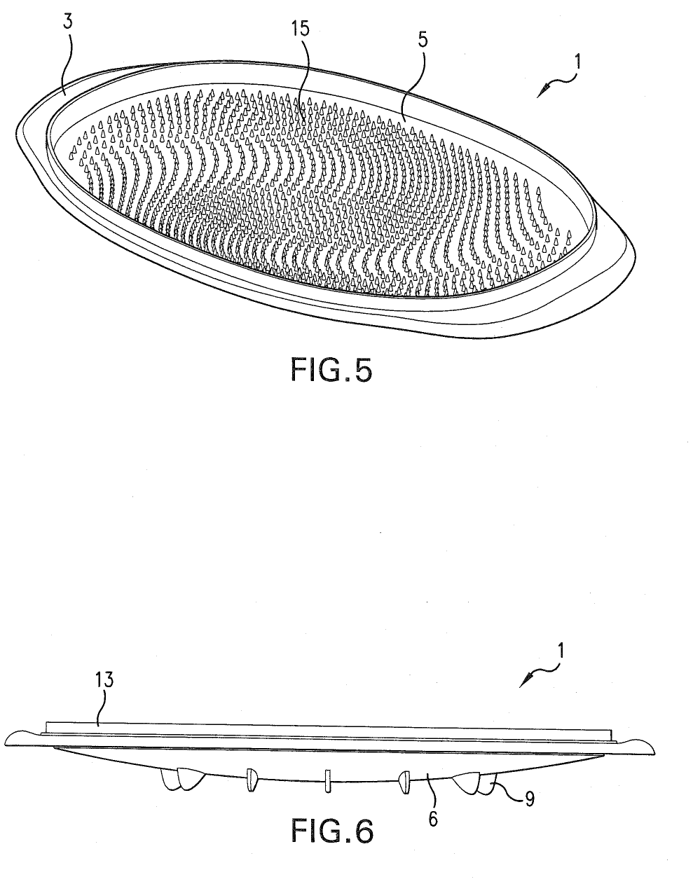

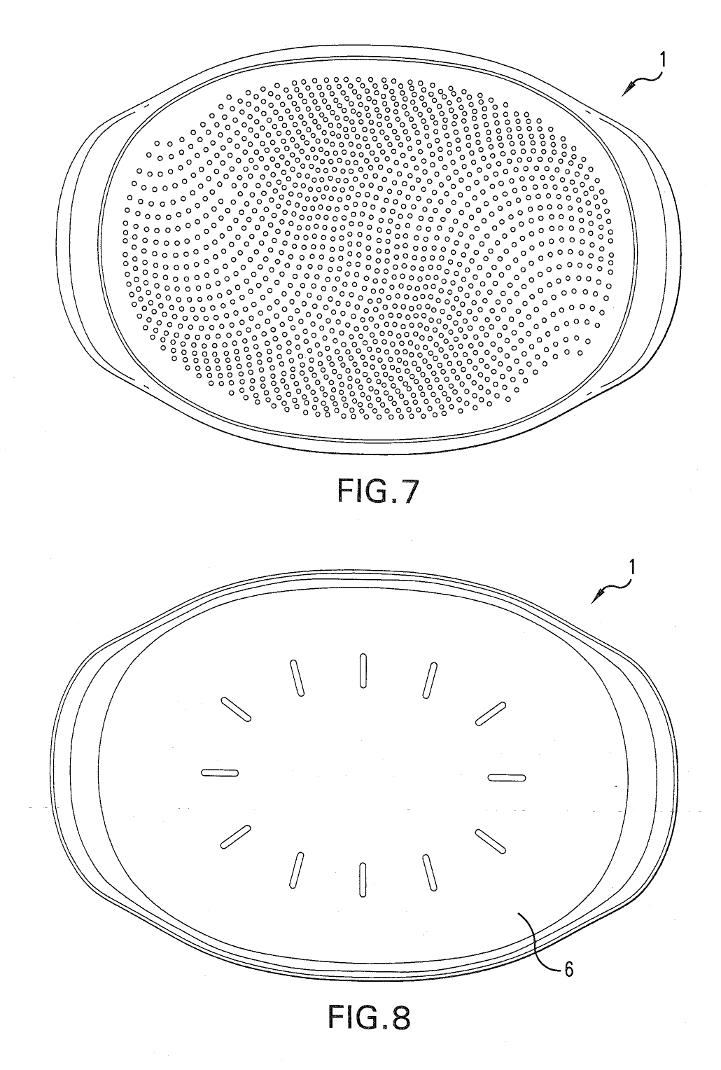

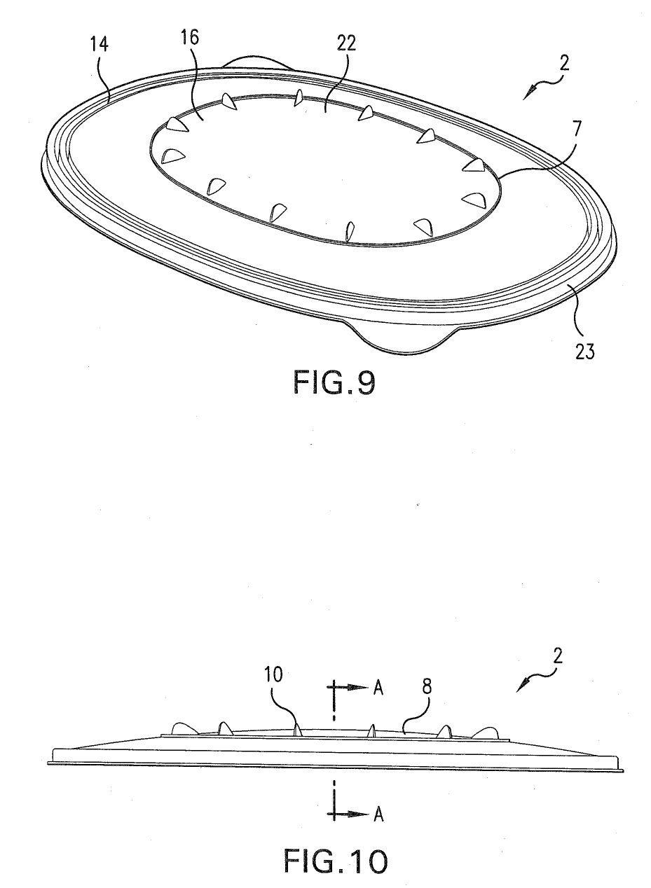

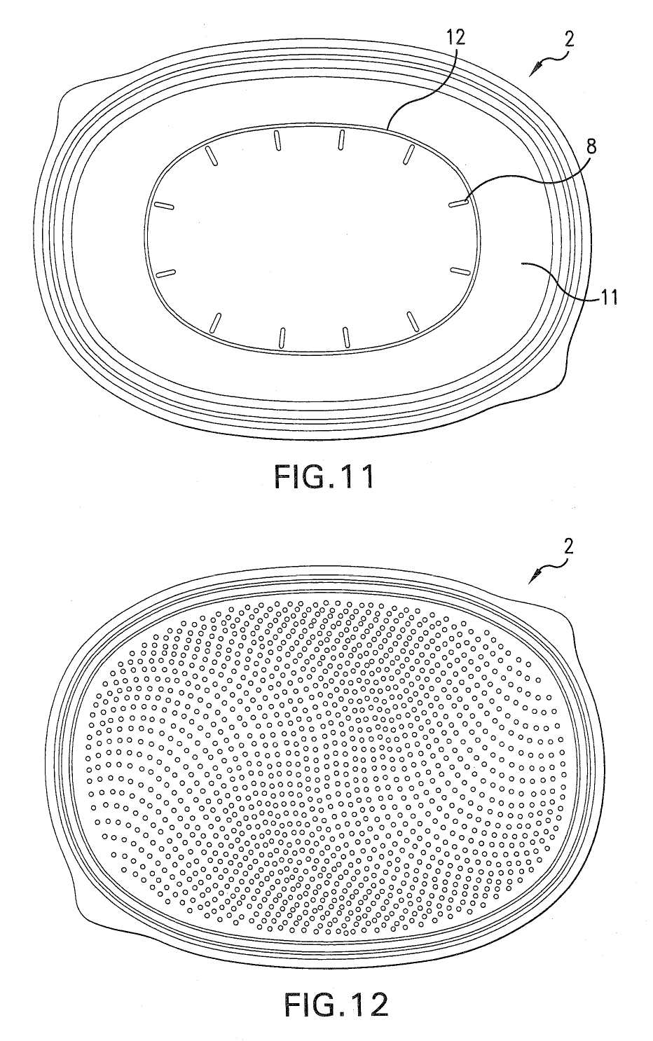

### DESCRIPTION OF THE PREFERRED EMBODIMENTS

A marinade container in accordance with the present invention is provided for marinating food products, such as for example a piece of meat, etc. The inventive marinade container has a base element which is identified with reference numeral 1 and a lid element which is identified with reference numeral 2.

The base element 1 and the lid element 2 are provided with handles 3 and 4 correspondingly. The base element 1 and the lid element 2 are optimally composed of a food compatible plastic material which is commonly used for food storage containers.

As can be seen from FIG. 2, the base element 1 and the lid element 2 are preferably dish-shaped, with convex outer surfaces and concave inner surfaces.

In particular, the base element 1 has an inner surface 5 and an outer surface 6, while the lid element 2 has an inner surface 7 and an outer surface 8.

When the lid element 2 is connected with the base element 1, the inner surfaces 5 and 7 of the base element 1 and the lid element 2 define therebetween an inner space for accommodating a piece of food product, for example a piece of meat, to be marinated.

The outer surfaces 6 and 8 of the base element 1 and the lid element 2 are provided with projections which are configured to allow the sealed container to rest stably on a supporting surface either on the base element 1 or on the lid element 2. In particular, the base element 1 is provided on its outer surface 6 with projections 9, while the lid element 2 is provided on its outer surface 8 with projections 10. Since the marinade container can rest stably on the support surface either on the projections 9 of the outer surface 6 of the base element 1 or on the projections 10 of the outer surface 8 of the lid element 2, the marination of the piece of food product in the marinade container is facilitated on both upper and lower surfaces of the piece of food product.

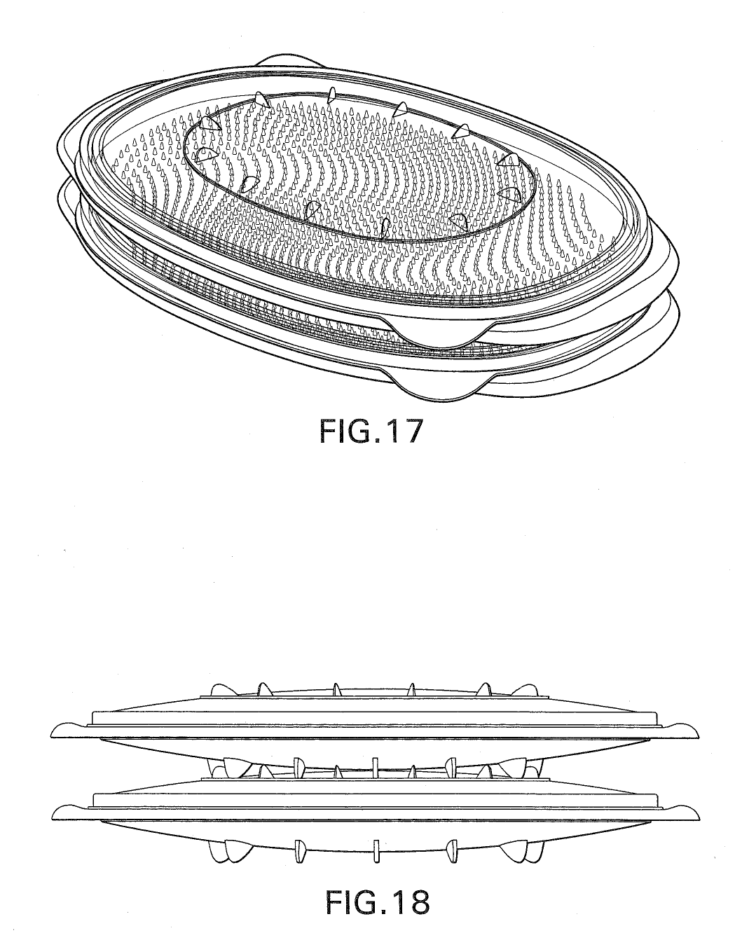

The outer surface 8 of the lid element 2 is provided with depressions 11. The depressions are configured so that the projections 9 of the base element are insertable in the depressions 11. This arrangement provides for stably stacking of the multiple marinade containers on top of one another as shown in FIGS. 17 and 18.

For orienting the projections 9 relative to the depressions 11 a peripherally closed projection 12 is provided on the outer surface 8 of the lid element 2.

The base element 1 and the lid element 2 are connected to form an air tight seal when sufficient force is provided to the elements to connect them with one another. For this purpose the base element has a lip 13, while the lid element has a groove 14, that are configured so that the lip 13 air tightly engages into the groove 14.

In accordance with an important feature of the present invention, the inner surfaces of the base element 1 and the lid element 2 are provided with a plurality of tines. The inner surface 5 of the base element 5 has a plurality of tines 15, while the inner surface 7 of the lid element 2 is provided with a plurality of tines 16. The tines 15 and 16 are configured so that they penetrate a piece of food product by puncturing holes in corresponding surfaces of the piece of food product, so as to provide a diffusion of marinade into the food product and thereby increase an effectiveness with which the piece of food product is marinated and made tender. The tines can be formed, for example, as substantially conical projections with substantially sharp tips.

In accordance with the present invention means are provided for adjusting of a vertical size of the inner space between the inner surface 5 of the base element 1 and the inner surface 7 of the lid element 2.

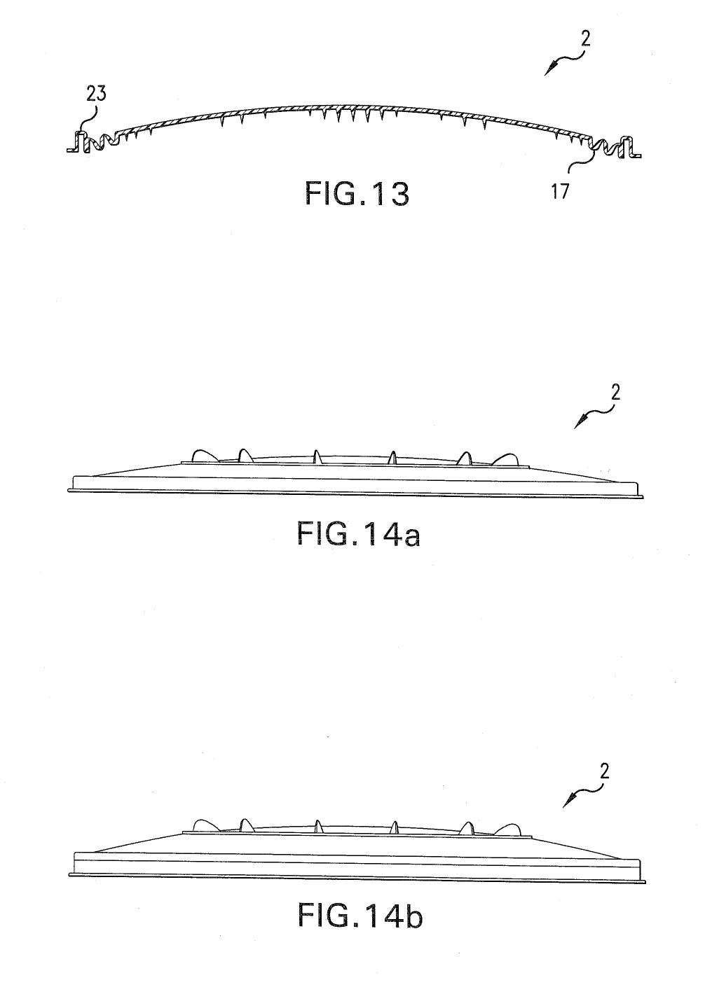

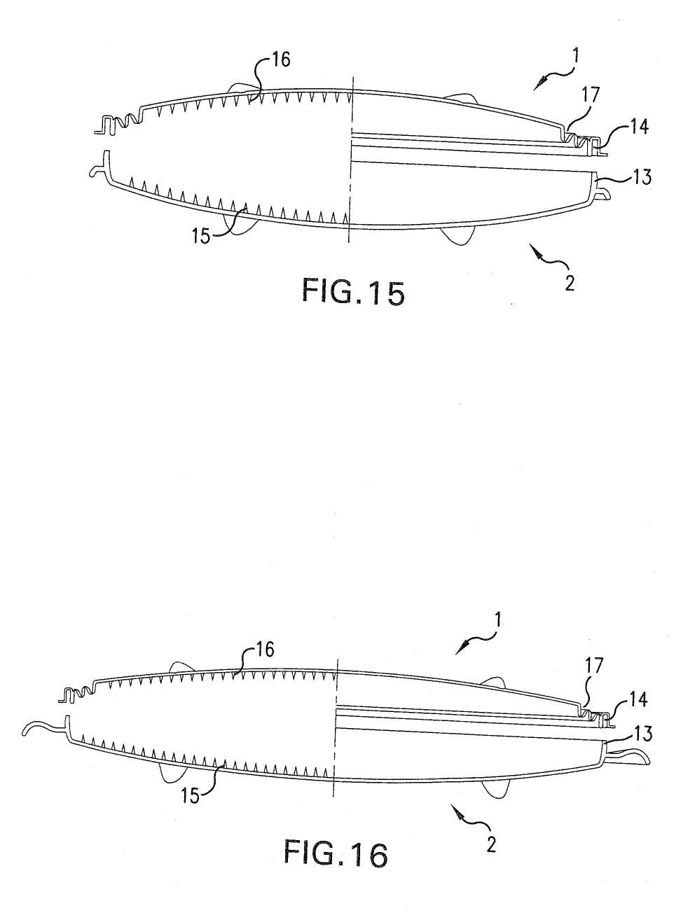

The adjusting means can be formed, for example, as a portion of one of the elements which allows the one element to move in a vertical direction toward and away from the other element. This portion is identified with reference numeral 17. It can be formed as a portion which is provided with at least one fold or a plurality of fold and configured, for example as a corrugated portion. As shown in FIG. 13 for the lid element 2, as a result, a main part of the lid element 2 can be displaced downwardly toward the base element 1 or away from the base element 1 so as to reduce or to increase the size of the inner space between the base element 1 and the lid element 2, in accordance with the thickness of a piece of food product to be marinated.

The displacement of the main portion, for example, of the lid element 2, must be such that when the piece of food product is located in the container between the base element 1 and the lid element 2, the tines 15 of the base element 1 and the tines 16 of the lid element 2 penetrate into the piece of food product and puncture holes in the lower surface of the piece of food product and in the upper surface of the piece of food product.

It should be mentioned that the force required to move the main portion, for example, of the lid element 2 downwardly toward the base element I or upwardly from the base element 1 is selected to be less than a force required to maintain the air-tight seal between the lid element 2 and the base element 1 due to the engagement of the lip 13 of the base element 1 into the groove 14 of the lid element 2.

The marinade container in accordance with the present invention operates in the following manner:

When for example the base element 1 is placed on a support surface, a piece of food product is placed into the base element 1 on its inner surface 5 provided with the tines 15. Then, the lid 2 is placed on the base element 1 so that its inner surface 7 faces the inner surface 5 of the base element 2, and a force is applied, so that the lip 13 of the base element 1 engages into the groove 14 of the lid element 2 and an air-tight connection of the two elements with one another is established. Then, a user displaces the main part of the lid element 2 toward the base element 1 or away from the base element 1, so that the piece of food product is accommodated tightly in the inner space formed between the inner surface 5 of the base element 1 and the inner surface 7 of the base element 2 and the tines 15 of the base element 1 puncture holes in the lower surface of the piece of food product, while the tines 16 of the inner surface 7 of the lid element 2 puncture holes in the upper surface of piece of the food product. The piece of the food produce is left in the marinade container for sufficient time to allow diffusion of marinade through the holes in the upper and lower surfaces of the piece of food product into the volume of the piece of food product.

It will be understood that each of the elements described above, or two or more together, may also find a useful application in other types of constructions differing from the type described above.

While the invention has been illustrated and described as embodied in a marinade container, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A marinade container, comprising a base element having an inner surface provided with a plurality of tines which are configured for puncturing holes in a surface of a piece of food product, said base element also having an outer surface; and a lid element having an inner surface provided with a plurality of tines which are configured for puncturing holes in a piece of food product, said lid element and said base element being connectable with one another so as to define an inner space in which a piece of food product can be accommodated and said tines on said inner surface of said base element and on said inner surface of said lid element being configured so that when the piece of food product is accommodated in said inner space said tines of said base element puncture holes in one surface of the piece of food product and said tines of said inner surface of said lid element simultaneously puncture holes in an opposite surface of the piece of food product for increasing a diffusion of marinade into the food product and for thereby increasing an effectiveness with which the piece of food product is marinated.

2. A marinade container as defined in claim 1, wherein said outer surface of said base element and said outer surface of said lid element are provided with a plurality of projections configured such that the marinade container can rest on a supporting surface in one position in which said base element is located below said lid element and said projections of said base element rest on the supporting surface, and in another position in which the marinade container is turned upside down, said lid element is located below said base element, and said projections of said lid element rest on the supporting surface.

3. A marinade container as defined in claim 1; and further comprising a plurality of projections provided on said outer surface of one of said elements and a plurality of depressions provided on said outer surface of the other of said elements, and configured so that for stacking at least two of the marinade containers on one another said projections on said outer surface of one of said elements are inserted in said depression on said outer surface of said other element.

4. A marinade container as defined in claim 1; and further comprising means for adjusting a vertical dimension of said inner space in accordance with a thickness of the piece of food product to be accommodated in said inner space so that the piece of a food product can be accommodated in said inner space and also said tines of said inner surface of said base element and said tines of said inner space of said lid element can reach and penetrate the surfaces of the piece of food product.

5. A marinade container as defined in claim 4, wherein said adjusting means include a portion of one of said elements which portion is configured so that it allows deflection of said one element relative to said other element, so that said one element can be located closer to said other element or farther from said other element to change the vertical dimension of said inner space.

6. A marinade container as defined in claim 5, wherein said portion allowing deflection is configured so that a force required for the deflection is less than a force required to keep the marinade container closed.

7. A marinade container as defined in claim 6, wherein said portion allowing the deflection of said one element is provided with at least one fold.

8. A marinade container as defined in claim 6, wherein said adjusting means is configured so that said lid element is displaceable downwardly toward said base element over a distance ensuring that said tines of said inner surface of said lid element puncture holes in the surface of the piece of food product.

9. A marinade container as defined in claim 1; and further comprising means for tightly connecting said elements with one another.

10. A marinade container, comprising a base element having an inner surface and an outer surface; a lid element having an inner surface and an outer surface, said inner surface of at least one of said elements being provided with a plurality of tines which are configured for puncturing holes in a surface of a piece of food; and means for adjusting a vertical dimension of an inner space formed between said inner surfaces of said base element and said lid element in accordance with a thickness of the piece of food product to be accommodated in said inner space.

11. A marinade container as defined in claim 10, wherein said adjusting means include a portion of one of said elements which is configured so that it allows deflection of said one element relative to the other of said elements, so that said one element can be located closer to said other element or farther from said other element to change the vertical dimension of said inner space.

12. A marinade container as defined in claim 11, wherein said portion allowing deflection is configured so that a force required for the deflection is less than a force required to keep the marinade container closed.

13. A marinade container as defined in claim 11, wherein said portion allowing the deflection of said one element is provided with at least one fold.

14. A marinade container as defined in claim 11, wherein said adjusting means is configured so that said one element is displaceable relative to said other element over a distance ensuring that said tines puncture holes in the surface of the piece of food product.

15. A marinade container as defined in claim 10, wherein both said elements are provided with tines arranged on their inner surfaces, said adjusting means being configured so that said one element is displaceable relative to said other element over a distance ensuring that said tines of said elements puncture both opposite surfaces of the piece of food product.
